(19) United States
(12) Patent Application Publication
(10) Pub. No.: US 2002/0003576 A1
(43) Pub. Date: Jan. 10, 2002

(54) Video camera apparatus

(76) Inventors: Kazuo Konishi, Sagamihara-shi (JP); Masafumi Umeda, Ome-shi (JP); Takao Katagiri, Ome-shi (JP); Kazuhiro Takashima, Tokyo (JP); Masao Iwasaki, Fuchu-shi (JP); Toshihiro Morohoshi, Kawasaki-shi (JP); Tomiyoshi Fukumoto, Kawasaki-shi (JP); Fuminori Yamazaki, Fussa-shi (JP)

Correspondence Address: Finnegan, Hendersn, Farabow,, Garrett & Dunner, L.L.P., 1300 I Street, N.W., Washington, DC, 20005-3315, US

(21) Appl. No.: 09/871,815

(22) Filed: Jun. 4, 2001

(30) Foreign Application Priority Data
Jun. 7, 2000 (JP) 2000-170525

(51) Int. Cl. H04N 7/00

(52) U.S. Cl. 348/232; 348/220; 348/552

(57) ABSTRACT

A video camera apparatus includes a video encoding section which performs intra- or inter-frame encoding for a video signal input from a solid state image sensor, a recording section which records the video signal compression-encoded by the video encoding section as a video file on a recording medium, and a control section which executes a first motion video shooting and recording mode for obtaining a video file including the compression-encoded video signal to be transmitted in real time to a partner destination via a network, and controls the video encoding section to match the bit rate of the encoded signal obtained by the video encoding section with the communication speed of the network used to transmit the video file when the first motion video shooting and recording mode is selected.

### CROSS-REFERENCE TO RELATED APPLICATIONS

This application is based upon and claims the benefit of priority from the prior Japanese Patent Application No. 2000-170525, filed Jun. 7, 2000, the entire contents of which are incorporated herein by reference.

### BACKGROUND OF THE INVENTION

The present invention relates to a video camera apparatus and, more particularly, to a video camera apparatus for recording a video signal obtained by video shooting after encoding it by a compression-encoding scheme such as MPEG4.

In recent years, a technique of transmitting still video data obtained by video shooting using a digital camera to a partner destination via the Internet has been developed along with the spread of digital cameras and the development of the Internet technique.

Recently, demands are arising for real time transmission of not only still video data but also motion video data via the Internet. A streaming reproduction technique is known as a real time transmission system for motion video data. According to this technique, a motion video file compression-encoded at a low bit rate is accumulated in a server computer in advance, and the accumulated motion video file is reproduced on each home computer via the Internet in real time while being transferred.

To create a motion video file usable in the streaming reproduction technique requires a dedicated encoding device, a file generating device, and the like. Video data obtained by video shooting using a home digital camera cannot be directly utilized for streaming reproduction.

More specifically, in recent years, various home digital video cameras (DV cameras) coping with a DV format and the like have been developed on the assumption that such video camera is to obtain high quality motion video data to be reproduced and watched on a TV or VCR. Since motion video data is always recorded with the highest quality of the camera, motion video data in the DV format cannot be directly used for real time transmission via a low bit rate communication channel.

Hence, it is desired to implement a video camera capable of easily obtaining motion video data optimal for communication via the Internet.

Known examples of the motion video data compression-encoding scheme are MPEG2, MPEG4, and MPEG7. Any of MPEG2, MPEG4, and MPEG7 performs high efficiency compression using the correlation between frames. This compression processing, however, requires a high speed processor. Thus, a video camera which must be equipped with a low-cost processor with low power consumption takes a long compression time and may not attain a target frame rate. In this case, some frames are omitted in compression processing, and a reproduced video becomes a jerky motion video.

Fixed point shooting for monitoring of a shop/factory/road, astronomical observation, or the like preferably adopts special shot (interval shot) of shooting one frame after a predetermined interval time because an object to be shot does not move. An encoding scheme such as MPEG2, MPEG4, or MPEG7 adds real time information as a time stamp to each encoded frame. Images obtained by interval shot every predetermined time are encoded as temporally successive images. If such encoded data are directly decoded and reconstructed, the images are reproduced using a time actually taken from the start to end of interval shot, and a wasteful reproduction time is consumed.

In general, a conventional DV camera can record not only motion video but also speech at the same time. However, a mode in which only speech is recorded is not prepared. Even if only speech is important, motion video has to be recorded, which wastefully consumes the recording capacity of a recording medium.

The conventional DV camera comprises a communication interface with a computer, but is only recognized as a camera by the computer. For this reason, exchange of motion video data between the camera and the computer requires dedicated software.

It is an object of the present invention to provide a video camera apparatus suitable for compatibility with the Internet or a computer.

### BRIEF SUMMARY OF THE INVENTION

The present invention provides a video camera apparatus comprising a solid state image sensor, a motion video encoding section which performs compression encoding including intra-frame encoding and inter-frame encoding for a motion video signal input from the solid state image sensor, a recording section which records the motion video signal compression-encoded by the motion video encoding section as a motion video file on a recording medium, and a control section which has a first motion video shooting and recording mode for obtaining a motion video file capable of transmitting the compression-encoded motion video signal in real time to a partner destination via a network, and controls the motion video encoding section so as to match a bit rate of an encoded signal obtained by the motion video encoding section with a communication speed of the network used to transmit the motion video file when the first motion video shooting and recording mode is selected.

This video camera apparatus has the first motion video shooting and recording mode for obtaining a motion video file capable of transmitting the compression-encoded motion video signal in real time to a partner destination via a network. When the first motion video shooting and recording mode is selected, the bit rate of an encoded signal is automatically set to match with the communication speed of a network used to transmit the motion video file. The user can easily obtain a motion video file suitable for video transmission via the Internet or the like by only selecting the first motion video shooting and recording mode.

When the first motion video shooting and recording mode is selected, the bit rate of an encoded signal obtained by a speech signal encoding section is also preferably automatically set to match with the communication speed of the network used to transmit the motion video file.

A second motion video shooting and recording mode in which an encoded signal having a higher bit rate than in the first motion video shooting and recording mode is recorded as a motion video file is prepared in addition to the first motion video shooting and recording mode. When the second motion video shooting and recording mode is selected, the bit rate of an encoded signal obtained by the motion video encoding section is automatically controlled to be higher than in the first motion video shooting and recording mode. To obtain a high quality motion video file to be played back on a TV or the like, the user selects the second motion video shooting and recording mode; and to obtain a motion video file to be communicated via the Internet, he/she selects the first motion video shooting and recording mode. With this operation, the user can easily attain a motion video file having an image quality (bit rate) coping with the application purpose.

The video camera apparatus further comprises an option selection section which selects an encoding option to be executed by the motion video encoding section. When an encoding delay by the motion video encoding section is detected, encoding by the motion video encoding section is switched to intra-frame encoding, and the motion video encoding section is caused to omit inter-frame encoding (e.g., motion detection or motion compensation). This can implement encoding at a target frame rate. Alternatively, encoding may be switched to intra-frame encoding on the basis of the motion vector size or the amount of hand blurring.

In an interval shot mode in which image sensing and recording of one or more frames are repetitively executed after a predetermined interval time, it is desirable to switch encoding by the motion video encoding section to intra-frame encoding, and cause the motion video encoding section to omit inter-frame encoding.

In the interval shot mode, the time stamp value of each frame added to the compression-encoded motion video signal recorded as the motion video file is displaced by another virtual value. Thus, the motion video file obtained by interval shot can be efficiently reproduced.

The video camera apparatus has a speech recording mode in which only a speech signal is recorded. In this speech recording mode, at least the solid state image sensor and the motion video encoding section are set to an OFF or standby state. In this case, the video camera apparatus can also be used as a so-called IC voice recorder. In particular, wasteful battery consumption can be suppressed by setting circuits other than a portion concerning speech recording to an OFF or standby state. As a result, long time speech recording can be realized.

The video camera apparatus further comprises an index image generation section which generates the index image of the motion video signal recorded as the motion video file on the basis of a predetermined one-frame video signal obtained from the solid state image sensor, and record the index image on the recording medium. The contents of each motion video file on the recording medium can be easily estimated from its index image.

The video camera apparatus further comprises a communication interface which connects the video camera apparatus to an information processing device, a recognition section which causes the information processing device to recognize the video camera apparatus as a storage device when the video camera apparatus is connected to the information processing device via the communication interface, and a control section which controls the recording medium of the video camera apparatus in accordance with an access request from the information processing device to the storage device. Since the information processing device can treat the video camera apparatus as a storage device, motion video files between the information processing device and the video camera apparatus can be easily exchanged.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing the arrangement of a video camera apparatus according to an embodiment of the present invention;

FIGS. 2A and 2B are views showing the outer appearance of the video camera apparatus according to the embodiment;

FIG. 3 is a block diagram showing a bit rate switching functional arrangement in the video camera apparatus according to the embodiment;

FIG. 4 is a table for explaining the motion video and Internet modes of the video camera apparatus according to the embodiment;

FIG. 5 is a table for explaining the motion video and Internet modes of the video camera apparatus and corresponding speech encoding schemes according to the embodiment;

FIG. 6 is a flow chart showing a bit rate control processing sequence by the video camera apparatus according to the embodiment;

FIG. 7 is a block diagram showing the first arrangement for switching a compression encoding option in the video camera apparatus according to the embodiment;

FIG. 8 is a block diagram showing the second arrangement for switching a compression encoding option in the video camera apparatus according to the embodiment;

FIG. 9 is a block diagram showing the third arrangement for switching a compression encoding option in the video camera apparatus according to the embodiment;

FIGS. 10A and 10B are views for explaining interval shot and time stamp displacement processing in the video camera apparatus according to the embodiment;

FIG. 11 is a table showing interval times usable in interval shot in the video camera apparatus according to the embodiment;

FIG. 12 is a block diagram showing the first functional arrangement concerning time stamp displacement in the video camera apparatus according to the embodiment;

FIG. 13 is a block diagram showing the second functional arrangement concerning time stamp displacement in the video camera apparatus according to the embodiment;

FIG. 14 is a block diagram showing the third functional arrangement concerning time stamp displacement in the video camera apparatus according to the embodiment;

FIG. 15 is a flow chart for explaining setting processing in the interval shot mode executed by the video camera apparatus according to the embodiment;

FIG. 16 is a block diagram showing circuits operated when the video camera apparatus according to the embodiment is in a voice only mode;

FIGS. 17A and 17B are views showing an example of status display representing that the video camera apparatus according to the embodiment operates in the voice only mode;

FIGS. 18A and 18B are views showing an example of status display for the video shooting residual time in the video camera apparatus according to the embodiment;

FIGS. 19A and 19B are views showing an example of status display for the battery residual capacity in the video camera apparatus according to the embodiment;

FIG. 20 is a block diagram showing a functional arrangement for adding a beep sound to a speech signal and recording the speech signal in the video camera apparatus according to the embodiment;

FIGS. 21A and 21B are views showing an example of status display for the residual recordable number of still videos in the video camera apparatus according to the embodiment;

FIG. 22 is a flow chart showing a voice only mode setting processing sequence executed by the video camera apparatus according to the embodiment;

FIG. 23 is a block diagram showing a functional arrangement for realizing an index generation function in the video camera apparatus according to the embodiment;

FIG. 24 is a view showing the relationship between a motion video file and index image recorded by the video camera apparatus according to the embodiment;

FIG. 25 is a view showing the relationship between the motion video shooting period and the index image in the video camera apparatus according to the embodiment;

FIGS. 26A and 26B are views each showing the use form of the index image in the video camera apparatus according to the embodiment;

FIG. 27 is a flow chart showing an index image generation processing sequence by the video camera apparatus according to the embodiment;

FIG. 28 is a block diagram showing a functional arrangement for using the video camera apparatus according to the embodiment as a storage device of a personal computer;

FIG. 29 is a block diagram showing circuits operated when the video camera apparatus according to the embodiment is connected to the personal computer;

FIG. 30 is a flow chart showing a processing sequence executed when the video camera apparatus according to the embodiment is connected to the personal computer; and

FIG. 31 is a flow chart showing a processing sequence in activating the video camera apparatus according to the embodiment.

### DETAILED DESCRIPTION OF THE INVENTION

A preferred embodiment of the present invention will be described below with reference to the several views of the accompanying drawing.

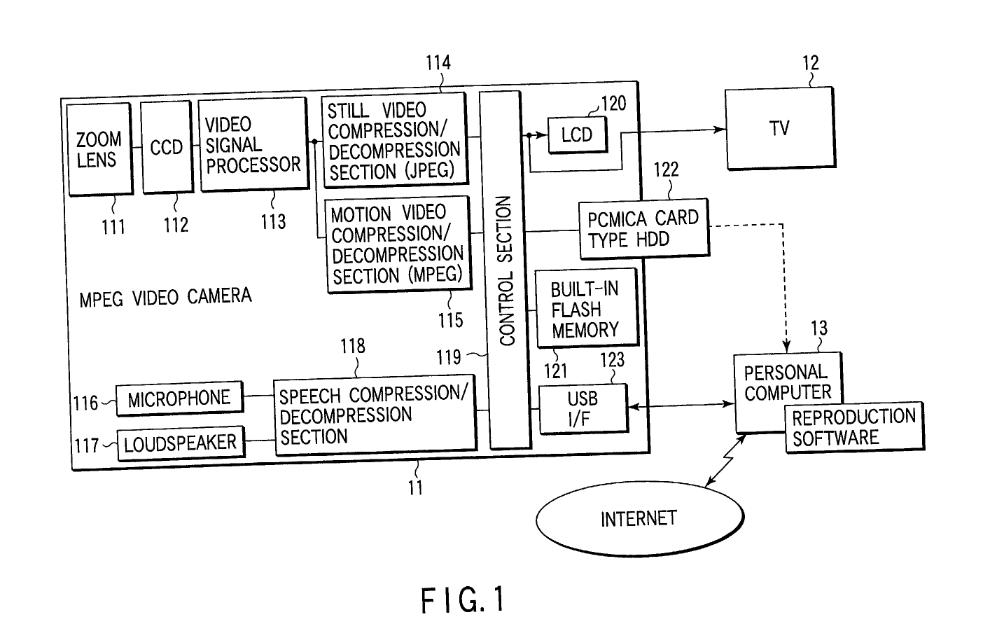

FIG. 1 is a block diagram showing the arrangement of a motion video camera apparatus according to an embodiment of the present invention. A video camera apparatus 11 shoots an image to obtain a motion video signal, compression-encodes the motion video signal in an MPEG4 encoding format, and records the encoded signal as a motion video file on a recording medium. The video camera apparatus 11 has a still video shooting and recording mode in addition to a motion video shooting and recording mode.

As shown in FIG. 1, the video camera apparatus 11 comprises a zoom lens 111, CCD 112, video signal processor 113, still video compression/decompression section 114, motion video compression/decompression section 115, microphone 116, loudspeaker 117, speech compression/decompression section 118, control section (CPU) 119, LCD monitor 120, built-in flash memory 121, PCMCIA card type hard disk drive 122, and USB interface 123.

The zoom lens 111 constitutes a video shooting optical system. An optical image formed by the zoom lens 111 is photoelectrically converted by the CCD 112 serving as a solid state image sensor. The motion video signal attained by photoelectric conversion is converted into a digital signal by the video signal processor 113. After the digital signal undergoes necessary video processing in the video signal processor, the digital video signal is sent to the still video compression/decompression section 114 in the still video shooting and recording mode and to the motion video compression/decompression section 115 in the motion video shooting and recording mode.

The still video compression/decompression section 114 compression-encodes the input video signal in a JPEG format. The resultant encoded signal is recorded as an encoded still video file on the built-in flash memory 121 or PCMCIA card type hard disk drive 122 by the control section 119. The PCMCIA card type hard disk drive 122 is larger in capacity than the built-in flash memory 121, and is detachably mounted on the video camera apparatus 11. When the PCMCIA card type hard disk drive 122 is mounted, the encoded still video file is recorded on the PCMCIA card type hard disk drive 122; and when the PCMCIA card type hard disk drive 122 is not mounted, the file is recorded on the built-in flash memory 121. The still video compression/decompression section 114 also has a function of decompressing an encoded still video file in the JPEG format. A video signal decompressed by the still video compression/decompression section 114 can be displayed on the LCD monitor 120 or a TV 12. The LCD monitor 120 is utilized not only as a reproduction display but also as a display viewfinder for an input video signal to be compressed.

The motion video compression/decompression section 115 compression-encodes, in the MPEG4 format, motion video signals successively input via the CCD 112 and video signal processor 113. Similar to MPEG2, MPEG4 is an encoding format having both the intra-frame encoding mode and inter-frame encoding mode, and uses a motion compensation prediction technique by motion vector detection (ME). Motion vector detection executes block search processing of searching a reference frame for the most approximate block for each block of interest within an input frame. The spatial deviation between the searched block and the block of interest is calculated as a motion vector. The image of the input frame is predicted from the reference frame on the basis of the motion vector, and the error signal between the predicted image and the input image is subjected to orthogonal transformation, quantization, and variable length encoding. This motion compensation prediction technique realizes high efficiency compression encoding using the correlation between frames. Since the bit rate is lower in MPEG4 than in MPEG2 for the same image quality, MPEG4 has a wider usable bit rate and stronger error robustness.

The signal encoded by the motion video compression/decompression section 115 is recorded as an encoded motion video file in the built-in flash memory 121 or PCMCIA card type hard disk drive 122 by the control section 119. When the PCMCIA card type hard disk drive 122 is mounted, the encoded motion video file is recorded in the PCMCIA card type hard disk drive 122; and when the PCMCIA card type hard disk drive 122 is not mounted, the file is recorded in the built-in flash memory 121. The motion video compression/decompression section 115 also has a decoding function of decompressing an encoded motion video file in the MPEG2/4 format. A motion video signal decompressed by the motion video compression/decompression section 115 can be displayed on the LCD monitor 120 or TV 12. The LCD monitor 120 is utilized not only as a reproduction display but also as a display viewfinder for an input image signal to be compressed.

The speech compression/decompression section 118 compresses and encodes a speech signal input via the microphone 116, and performs decoding processing of decompressing a compression-encoded speech file to output the resultant speech. In the motion video shooting and recording mode, compression encoding of a speech signal by the speech compression/decompression section 118 is generally done at the same time. In this case, an encoded motion video signal and encoded speech signal are multiplexed by the control section 119, and the multiplexed data is recorded as an encoded motion video file.

The USB interface 123 is a communication interface with an external information processor such as a personal computer 13. Encoded still video/motion video files can be exchanged between the built-in flash memory 121 or PCMCIA card type hard disk drive 122 and the personal computer 13 via the USB interface 123. Note that the PCMCIA card type hard disk drive 122 is implemented as a PCMCIA card of type 2, and can be used by being inserted into the PCMCIA card slot of the personal computer 13. An encoded motion video file obtained by video shooting using the video camera apparatus 11 is in the MPEG4 format, so that the motion video can be smoothly transmitted from the personal computer 13 to the Internet.

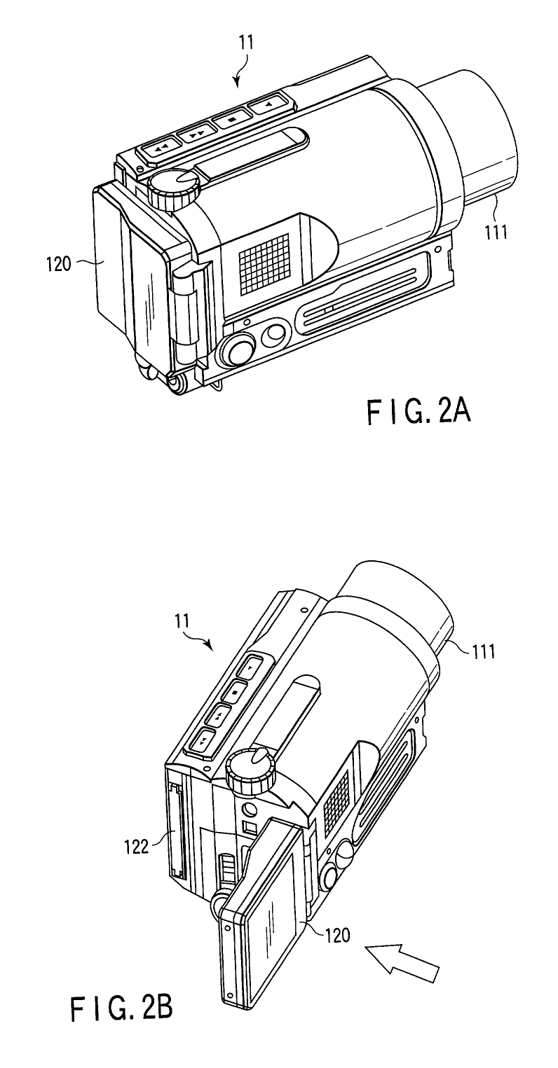

FIGS. 2A and 2B show the outer appearance of the video camera apparatus 11. FIG. 2A shows a state in which the LCD monitor 120 is stored at a closed position such that the display surface of the LCD monitor 120 faces the back surface of the main body. FIG. 2B shows a state in which the LCD monitor 120 is opened from the closed position and rotated such that the display surface can be observed from a direction indicated by the arrow.

The main body of the video camera apparatus 11 has various operation buttons concerning video shooting, reproduction, setting of the operation mode, and the like. The above-mentioned zoom lens ill is attached to the lens barrel. The LCD monitor 120 is attached to the back surface of the main body, and a PCMCIA card slot for inserting the PCMCIA card type hard disk drive 122 is also formed in the back surface of the main body.

<Video Mode and Internet Mode>

Two video shooting/recording modes set in the video camera apparatus 11 of this embodiment will be explained.

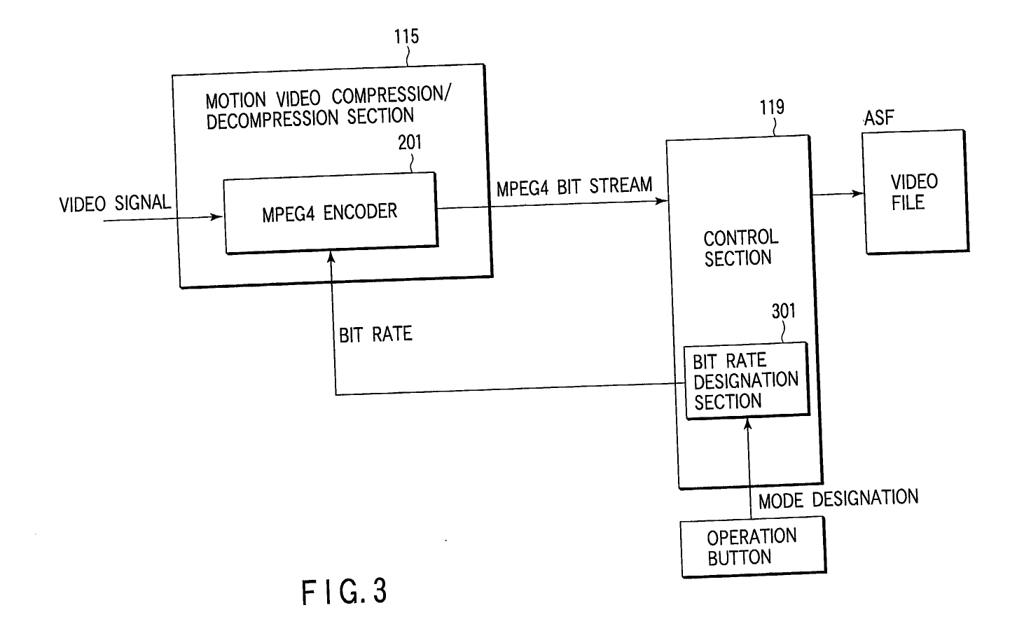

The video camera apparatus 11 has two video shooting/recording modes, i.e., video mode (VIDEO MODE) and Internet mode (INTERNET MODE). The video mode is a mode for shooting a high quality motion video, and is mainly used to obtain an encoded motion video file to be reproduced and displayed on the TV 12 or personal computer 13. The Internet mode is a mode for obtaining an encoded motion video file having a low bit rate that is suitable for real time transfer of a motion video via the Internet. The user can properly select the video mode and Internet mode with an operation button. When the video mode is selected, motion video compression encoding at a high bit rate that is necessary to attain high quality is executed. When the Internet mode is selected, the target bit rate of motion video compression encoding is automatically switched to a value optimal for real time transfer of a motion video via the Internet. An arrangement for switching the bit rate in accordance with selection of the video mode/Internet mode is shown in FIG. 3.

As shown in FIG. 3, the control section 119 comprises a bit rate designation section 301. The bit rate designation section 301 variably sets the target bit rate in accordance with the application purpose of an encoded motion video file obtained in the motion video shooting and recording mode. If the video mode is selected by the operation button, the bit rate designation section 301 designates the first target bit rate with respect to an MPEG4 encoder 201 arranged in the motion video compression/decompression section 115. The MPEG4 encoder 201 executes motion video compression encoding so as to obtain an encoded bit stream having the designated target bit rate. If the Internet mode is selected by the operation button, the bit rate designation section 301 designates the second target bit rate (second target bit rate<first target bit rate) with respect to the MPEG4 encoder 201 arranged in the motion video compression/decompression section 115. The MPEG4 encoder 201 executes motion video compression encoding so as to obtain an encoded bit stream having the designated target bit rate. The bit rate of the encoded bit stream can be controlled by, e.g., adjusting the quantization step size and changing the number of allocation bits.

An encoded bit stream (MPEG4 bit stream) output from the MPEG4 encoder 201 is input to the control section 119 where the bit stream is converted into, e.g., an ASF (Advanced Streaming Format) file format. The converted bit stream is recorded on the recording medium (built-in flash memory 121 or PCMCIA card type hard disk drive 122). The ASF file format is used to provide multimedia data as streaming data via a network, and can include not only videos but also speech and texts in the same ASF file data.

<Bit Rate>

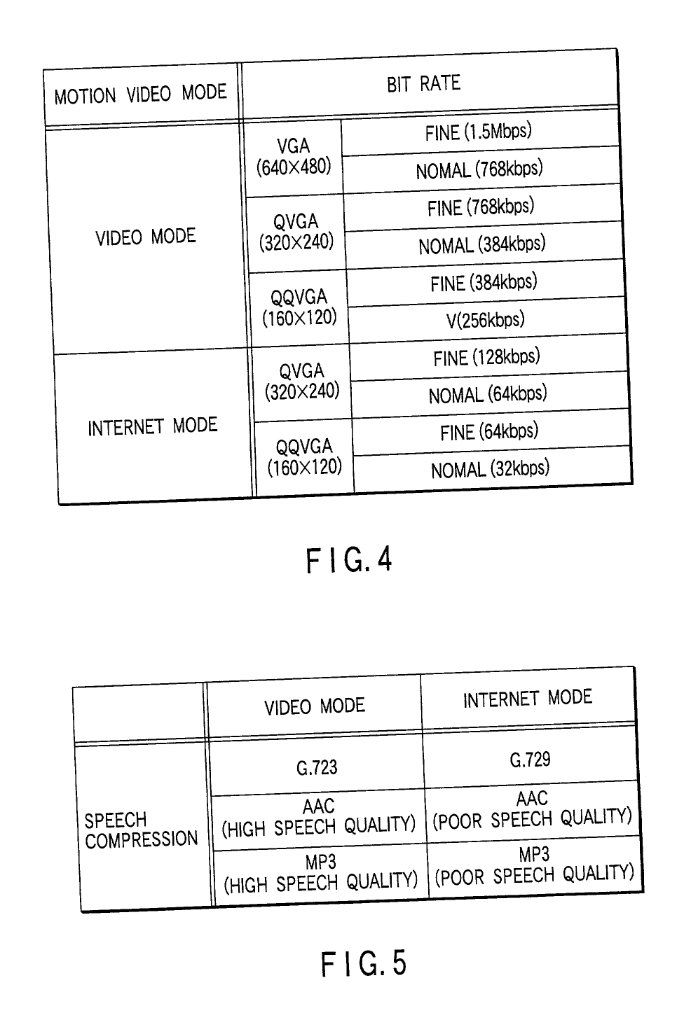

FIG. 4 shows the relationship between the video mode (VIDEO MODE) and Internet mode (INTERNET MODE), and corresponding bit rates. In the video mode, as shown in FIG. 4, three resolutions VGA (640×480), QVGA (320×240), and QQVGA (160×120) can be used. For each resolution, high image quality (FINE) and normal image quality (NORMAL) can be selected. In the Internet mode, two resolutions QVGA (320×240) and QQVGA (160×120) can be used. For each resolution, high image quality (FINE) and normal image quality (NORMAL) can be selected.

When the user selects FINE of QVGA (320×240), the bit rate is set to 768 kbps in the video mode, but is switched to a lower rate of 128 kbps in the Internet mode. The bit rate of 128 kbps corresponds to the maximum transfer rate of an ISDN network. Even for the same resolution, the bit rate is automatically changed between the video mode and the Internet mode. A bit rate conforming to the communication speed of a network is always set in the Internet mode.

<Bit Rate Control of Speech Signal>

Bit rate control of a speech signal in the motion video shooting and recording mode will be described.

In this embodiment, the bit rate is controlled even for a speech signal in addition to a motion video signal so as to change the bit rate between the video mode and the Internet mode. That is, the control section 119 designates, to the speech compression/decompression section 118, encoding at a high bit rate for high speech quality in the video mode, and encoding at a low bit rate in accordance with the communication speed of a network in the Internet mode.

FIG. 5 shows the relationship between the video and Internet modes, and speech compression encoding systems used in these modes.

The bit rate of a speech signal in the Internet mode can be decreased by switching the speech compression encoding system such that the video mode uses a G.723 encoding system and the Internet mode uses a G.729 encoding system lower in bit rate than the G.723 standard. When a speech compression encoding system such as AAC or MP3 is used, the bit rate can be variably set in this speech compression encoding, and can be controlled such that a high bit rate for high speech quality is designated in the video mode and a low bit rate is designated in accordance with the communication speed of a network in the Internet mode.

The flow chart of FIG. 6 shows a bit rate control processing sequence by the control section 119.

The control section 119 determines whether a motion video shooting and recording mode designated by the user is the video mode or the Internet mode (step S101). If the motion video shooting and recording mode is the video mode (VIDEO), the control section 119 designates to the motion video compression/decompression section 115 a target bit rate for the video mode that corresponds to the current resolution and image quality FINE/NORMAL designated by the user, and sets the bit rate of motion video encoding to a high bit rate for high image quality (step S102). The control section 119 selects high bit rate speech encoding, and designates it to the speech compression/decompression section 118 (step S103). If the motion video shooting and recording mode is the Internet mode (INTERNET), the control section 119 designates to the motion video compression/decompression section 115 a target bit rate for the Internet mode that corresponds to the current resolution and image quality FINE/NORMAL designated by the user, and sets the bit rate of motion video encoding to a low bit rate for network transmission (step S104). The control section 119 selects low bit rate speech encoding, and designates it to the speech compression/decompression section 118 (step S105).

In this embodiment, the bit rate in the Internet mode is determined based on the designated resolution and designated image quality. It is also possible that the user selects the communication speed or type of network to be used, and a corresponding resolution and bit rate are automatically set.

<Option Control of Motion Image Compression Encoding>

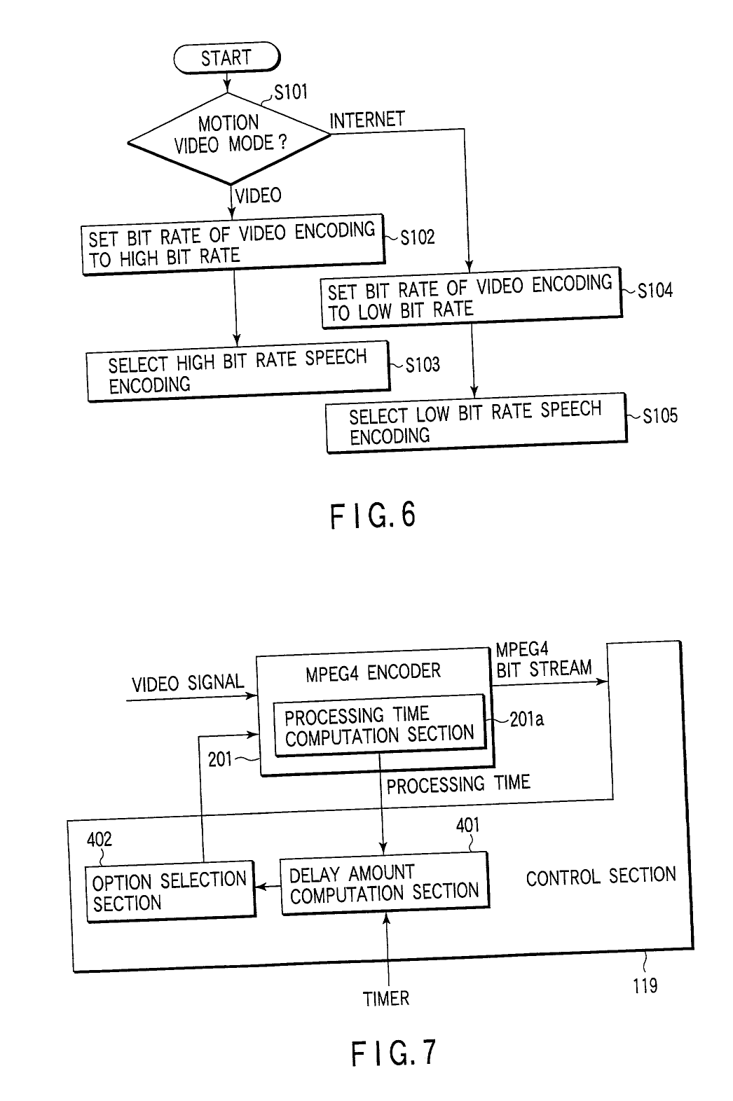

Control of automatically selecting a motion video compression encoding option will be explained with reference to FIGS. 7 to 9.

In general, a motion video compression encoding device is designed to attain the highest image quality at a designated bit rate. This motion video compression encoding device requires a high speed processor. A home digital video camera must satisfy low cost and low power consumption, so it is difficult to use such a high speed processor. To realize motion video compression encoding at a frame rate at which a relatively low speed processor is enough to implement the motion video compression/decompression section 115, this embodiment has the following automatic option selection functions.

When encoding by the motion video compression/decompression section 115 delays, a compression encoding option is automatically switched to an option smaller in processor load.

Motion video encoding is switched to intra-frame encoding on the basis of the motion vector size or the amount of hand blurring, and the motion video compression/decompression section 115 omits inter-frame encoding (e.g., motion detection or motion compensation).

Detailed control will be described.

FIG. 7 shows an arrangement for switching a compression encoding option on the basis of an encoding delay.

The MPEG4 encoder 201 comprises a processing time computation section 201a. The processing time computation section 201a computes a time (processing time) taken by the MPEG4 encoder 201 for compression encoding per frame. The processing time value is sent to a delay time computation section 401 arranged in the control section 119. The delay time computation section 401 uses the time information from a timer in the video camera 11 to sequentially compute an average processing time up to the present taken for compression encoding per frame, and compares the average processing time with a designated target frame rate (e.g., 30 fps) to obtain an encoding delay time. When the delay time increases to a value at which encoding at the target frame rate becomes impossible, the delay time computation section 401 sends the delay time at that time to an option selection section 402 arranged in the control section 119.

The option selection section 402 selects and designates a compression encoding option to be executed with respect to the MPEG4 encoder 201, and has a table representing the improvement amount of a processing time attained when each of options determined as compression encoding optional functions is enabled/disabled. The improvement amount of the table is based on a value measured in advance. The option selection section 402 switches the compression encoding option based on the delay time so as to reduce the computation amount of the processor by an amount corresponding to the input delay time. More specifically, the option selection section 402 selects an option in which compression encoding by the MPEG4 encoder 201 is switched to intra-frame encoding and the MPEG4 encoder 201 is caused to temporarily omit inter-frame encoding (e.g., motion detection or motion compensation). An arbitrary option can be switched in accordance with the MPEG4 standard as far as the option is switched to decrease the computation amount.

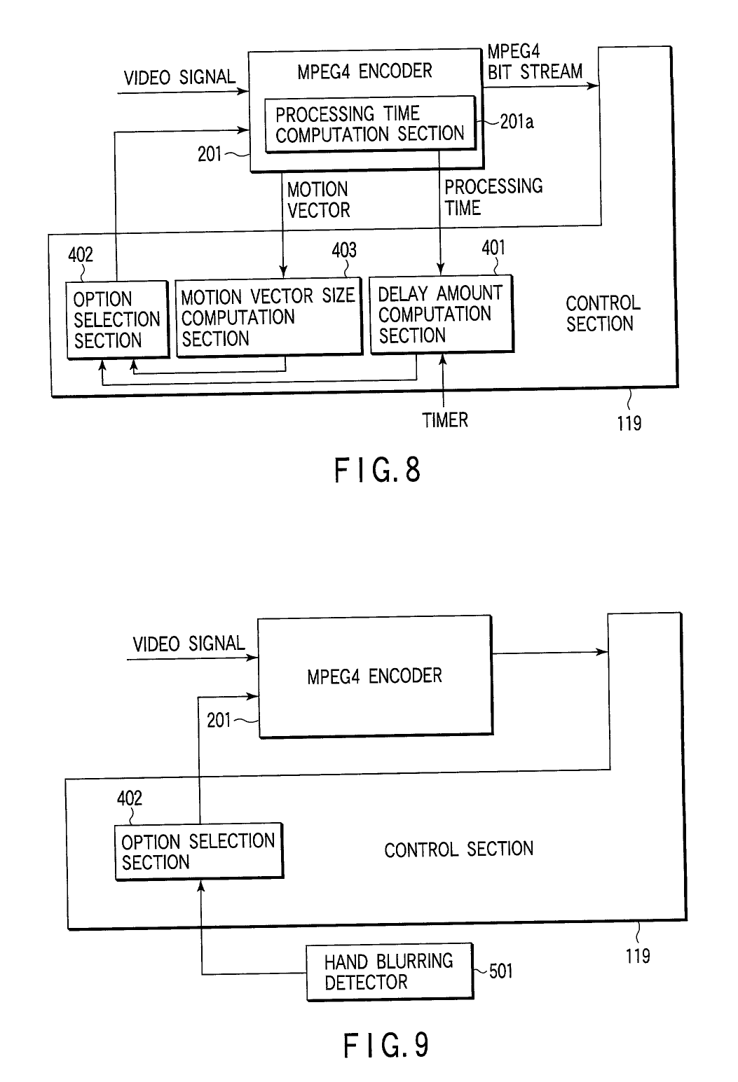

FIG. 8 shows an arrangement for switching a compression encoding option on the basis of a motion vector size.

In this embodiment, the control section 119 incorporates a motion vector size computation section 403 in addition to the delay time computation section 401 and option selection section 402. The motion vector size computation section 403 checks a motion vector value obtained by motion vector detection processing by the MPEG4 encoder 201, and when the motion vector value exceeds a predetermined value, instructs the option selection section 402 to switch an option. In response to the option switching instruction from the motion vector size computation section 403, the option selection section 402 selects an option in which compression encoding by the MPEG4 encoder 201 is switched to intra-frame encoding and the MPEG4 encoder 201 is caused to temporarily omit inter-frame encoding (e.g., motion detection or motion compensation).

Generally when the background and object hardly move in an input image, the error between a predicted image and the input image is small, inter-frame compression processing can be performed at high efficiency, and the processing time does not influence the frame rate. To the contrary, when the user holds the video camera apparatus 11 to shoot a motion video, the image correlation between frames decreases owing to hand blurring, pan, zoom, or short cut-in, and the motion between frames cannot be detected. In this case, the error between a predicted image and an input image increases, and encoding requires a large computation amount. Processing such as motion detection or motion compensation becomes eventually useless to waste an extra calculation amount. In this case, the option selection section 402 switches the encoding mode to the intra-frame encoding mode to temporarily stop motion detection/motion compensation processing. This can reduce the computation amount.

FIG. 9 shows an arrangement for switching a compression encoding option on the basis of the amount of hand blurring.

In this embodiment, the compression encoding option is switched based on a signal from a hand blurring detector 501 arranged in the video camera apparatus 11. The hand blurring detector 501 is formed from, e.g., a dedicated sensor, and when detecting hand blurring of a predetermined value or more, instructs the option selection section 402 to switch the option selection section 402. In response to the option switching instruction from the hand blurring detector 501, the option selection section 402 selects an option in which compression encoding by the MPEG4 encoder 201 is switched to intra-frame encoding and the MPEG4 encoder 201 is caused to temporarily omit inter-frame encoding (e.g., motion detection or motion compensation).

<Interval Shot>

An interval shot mode (interval REC) used in this embodiment will be explained.

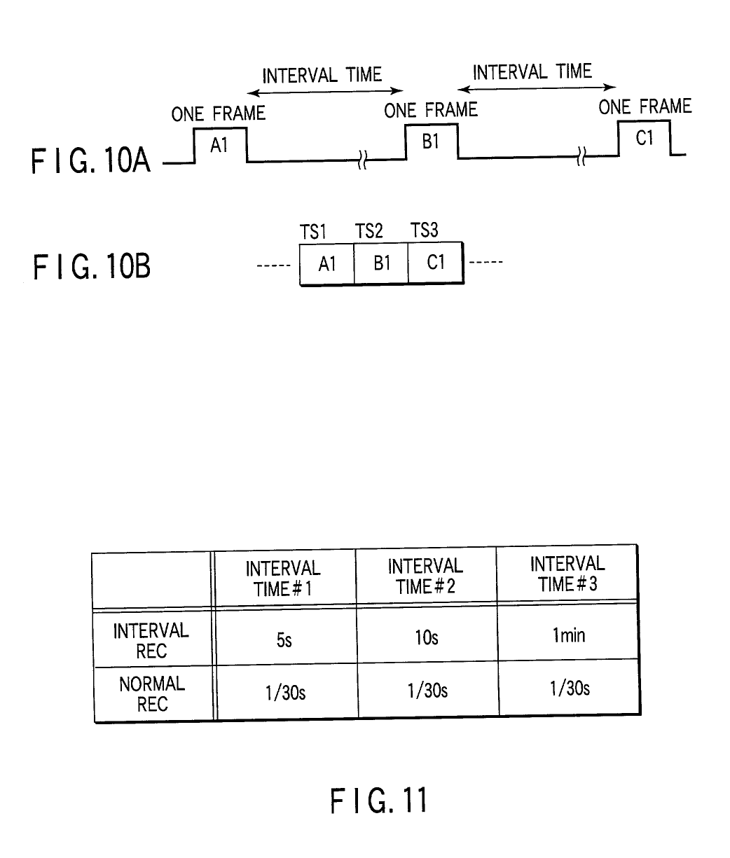

The interval shot mode is a motion video shooting/recording mode for fixed point shooting that is used for monitoring of a shop/factory/road, astronomical observation, observation of a flower's growth, or the like. This interval shot mode can be used in both the video and Internet modes. In the interval shot mode, an image can be shot and recorded for each frame or several successive frames after a predetermined interval time. This state is shown in FIG. 10A.

FIG. 10A shows an example in which one frame is shot every interval time. After a 1-frame image (A1) is captured from the CCD 112 and video signal processor 113, image capture is suspended for the interval time, and a one-frame image (B1) is captured again upon the lapse of the interval time. Captured images A1, B1, and C1 are images having different shooting times by the interval time. The images A1, B1, and C1 are input to the MPEG4 encoder 201 at intervals corresponding to the differences between the real shooting times of the images. In this case, a time stamp representing the real time is added for each encoded frame to a bit stream obtained by the MPEG4 encoder 201. If the encoded file is directly decoded and reconstructed, an image is undesirably reproduced using a time taken for actual video shooting.

To prevent this, as shown in FIG. 10B, this embodiment displaces the value of the time stamp (TS) of each frame added to a motion video signal recorded as an encoded motion video file by another virtual value. The encoded images A1, B1, and C1 are assigned time stamps TS1, TS2, and TS3 corresponding to a case wherein these images are temporally successive frames.

The interval time in the interval shot mode includes three times, i.e., 5 sec, 10 sec, and 1 min, as shown in FIG. 11, and the user can select any of the times in accordance with the purpose of interval shot. To the contrary, the interval time is 1/30 sec in normal motion video shooting/recording. Even if the interval time of 5 sec, 10 sec, or 1 min is selected, the values of the time stamps TS1, TS2, and TS3 after displacement is delayed by 1/30 sec.

Displacement of the time stamp enables observing necessary motion video within a short time without using special reproduction such as fast forward in reproducing an encoded motion video file.

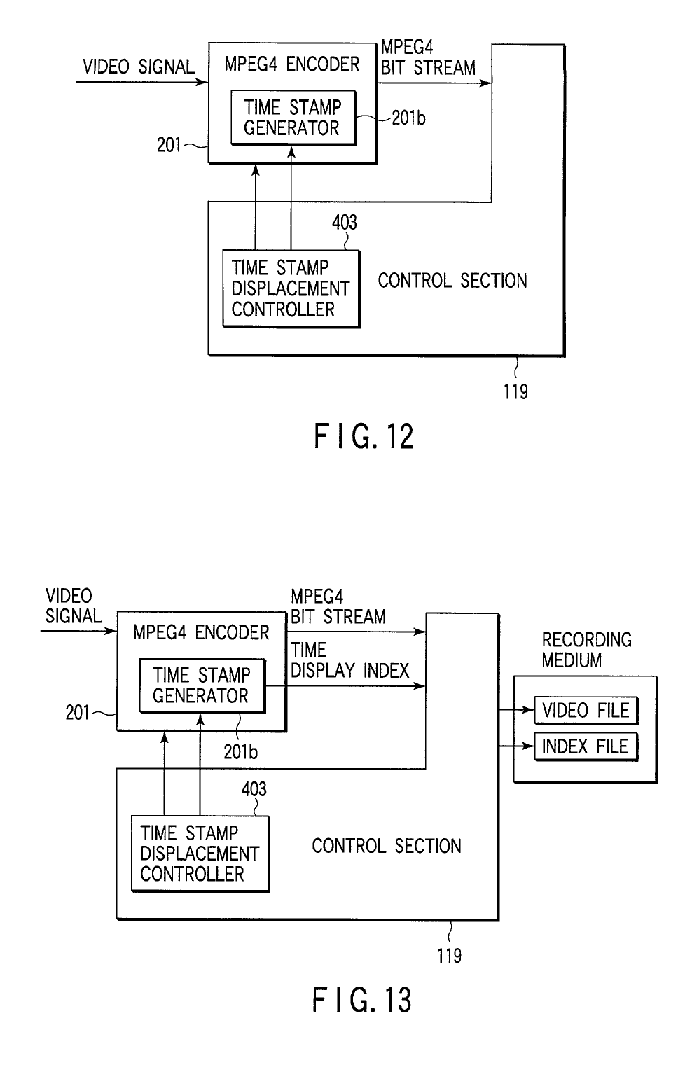

FIG. 12 shows the first arrangement for displacing a time stamp.

As shown in FIG. 12, the MPEG encoder 201 comprises a time stamp generator 201b, and the control section 119 comprises a time stamp displacement controller 403. The time stamp generator 201b normally generates as a time stamp a value corresponding to real encoding time for each encoded frame, and the time stamp value is displaced by another virtual value by the operation of the time stamp displacement controller 403. Displacement of the time stamp is controlled by replacing the time stamp of an encoded frame with a value updated every 1/30 sec upon the lapse of every designated interval time.

FIG. 13 shows the second arrangement for displacing the time stamp.

In this example, before the time stamp of real time generated by the time stamp generator 201b is displaced by a virtual value, the generated time stamp of real time is transferred as a time information index to the control section 119, and an index file other than an encoded motion video file is generated. A time stamp to be added to a bit stream recorded as an encoded motion video file is displaced by a virtual value in accordance with the interval time, similar to FIG. 12. By referring to the contents of the index file, the user can easily recognize a frame and its real shooting time.

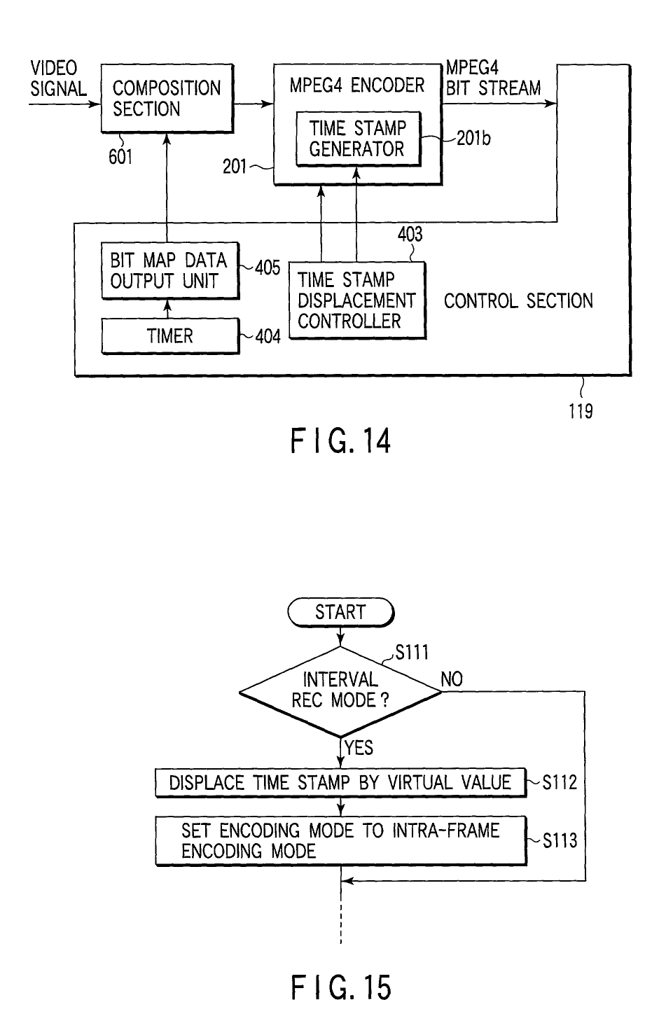

FIG. 14 shows the third arrangement for displacing the time stamp.

In this example, the time stamp of real time is synthesized as video information such as bit map information onto a frame, and encoded. That is, the control section 119 comprises a timer 404 and bit map data output unit 405 in addition to the time stamp displacement controller 403. The timer 404 supplies real time to the bit map data output unit 405 every interval time. The bit map data output unit 405 generates video information representing real time from the timer 404, and outputs it to a synthesizer 601 connected to the input of the MPEG4 encoder 201. It is also possible to prepare pieces of video information representing times for respective resolutions in the video camera apparatus 11 and output corresponding video information.

The synthesizer 601 synthesizes the video information from the bit map data output unit 405 onto a frame input every interval time, and outputs the synthesized image to the MPEG4 encoder 201, which encodes the frame to which the video information representing real time is synthesized. A time stamp to be added to a bit stream recorded as an encoded motion video file is displaced by a virtual value in accordance with the interval time, similar to FIG. 12.

The flow chart of FIG. 15 shows a processing sequence by the control section 119.

The control section 119 determines whether a motion video shooting and recording mode designated by the user is the interval shot mode (step S112). If YES in step S112, the control section 119 sets the time stamp displacement controller 403 so as to displace a time stamp by a virtual value (step S112), and switches the encoding mode of the MPEG4 encoder 201 to the intra-frame encoding mode (step S113). In this state, the interval shot starts. The intra-frame encoding mode is used in the interval shot mode in order to prevent an increase in the computation amount of encoding owing to wasteful processing such as motion detection and motion compensation.

<Voice Only Mode>

A voice only mode set in the video camera apparatus 11 of this embodiment will be described. The video camera apparatus 11 can be greatly downsized because it does not have any movable portion such as a recording tape, unlike a DV camera. The voice only mode is an operation mode for using the video camera apparatus 11 as a so-called IC recorder by utilizing the “downsizing” feature of the video camera apparatus 11. In this mode, no motion or still videos are recorded, and only speech is recorded.

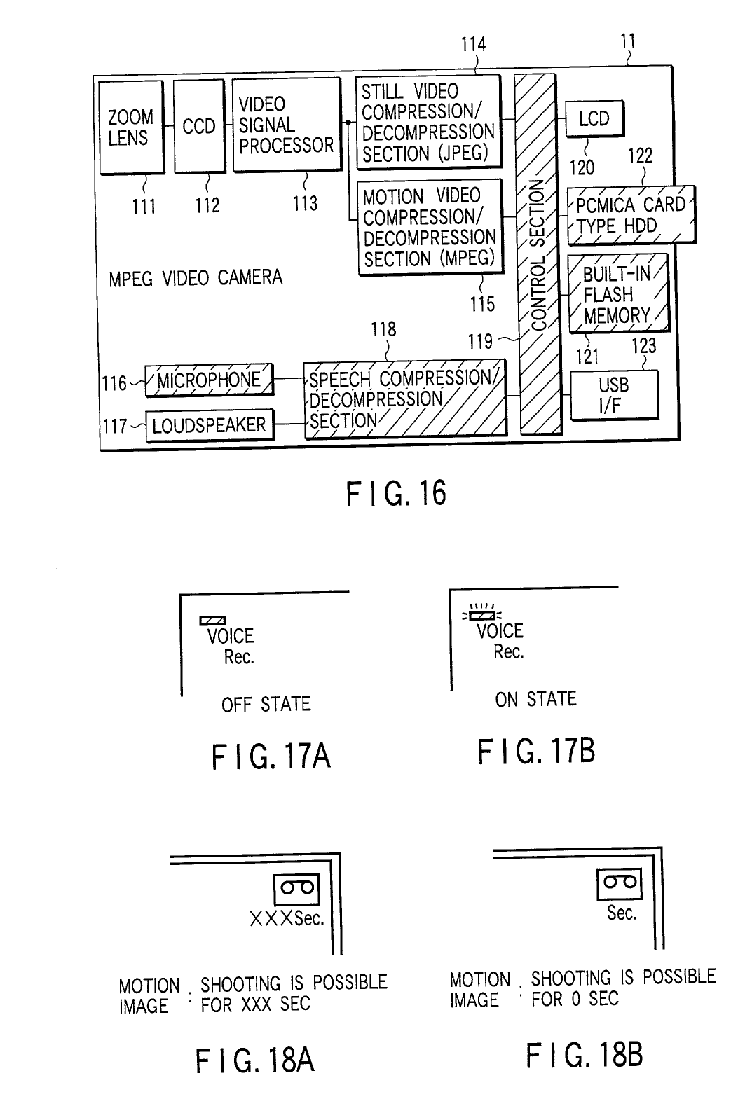

FIG. 16 shows circuits used and not used in the voice only mode. In the voice only mode, the operations of circuits concerning input of video signals such as still and motion videos, signal processing, encoding, and display are set in an OFF or standby state by stopping clocks, decreasing the clock rate, or stopping power supply. As represented by oblique lines in FIG. 16, only circuits concerning speech recording are set in an ON state. This can prolong the battery driving time of the video camera apparatus 11, i.e., the continuous speech recording time using the battery.

FIGS. 17A and 17B show an example of status display in the voice only mode. The video camera apparatus 11 has a status display LED for the voice only mode. The LED is OFF in an operation mode such as the motion video shooting and recording mode other than the voice only mode, as shown in FIG. 17A, and is ON (flickers at a predetermined time interval) in the voice only mode, as shown in FIG. 17B. Even if the LCD monitor 120 is OFF, the user can confirm that the video camera apparatus 11 operates in the voice only mode.

A display example and operation when the residual capacity of the recording medium (built-in flash memory 121 or PCMCIA card type hard disk drive 122) becomes small will be explained with reference to FIGS. 18A and 18B.

FIG. 18A shows a state in which the LCD monitor 120 displays during motion video shooting that the motion video shooting residual time is XXX sec, and FIG. 18B is a display example of the LCD monitor 120 when the motion video shooting residual time is 0 sec. When the motion video shooting residual time becomes 0 sec, this is displayed as shown in FIG. 18B, and the operations of circuits concerning input of video signals, signal processing, encoding, and display processing are set to an OFF or standby state. As shown in FIG. 16, only circuits concerning speech recording operate, and speech signals smaller in data amount than video signals are recorded as an emergency workaround. By automatically switching the operation mode to the voice only mode, only speech signals can be continuously recorded.

The same display and switching to the voice only mode can be performed even when still videos are shot (FIGS. 21A and 21B).

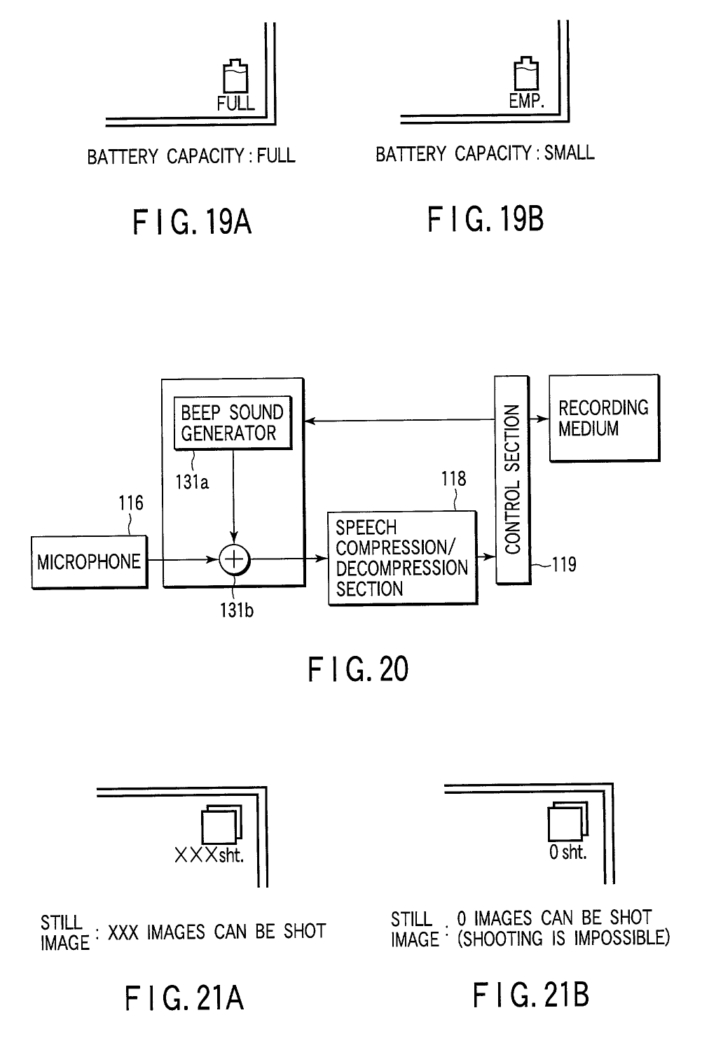

FIGS. 19A and 19B show display examples when the battery residual capacity becomes small. FIG. 19A shows a display example when the battery is fully charged, and FIG. 19B shows a display example when the battery level decreases to a level (low battery level) in which motion and still video shooting and recording cannot be continued. If the battery level decreases to the low battery level in the motion or still video shooting mode, this is displayed as shown in FIG. 19B, and the operations of circuits concerning input of video signals, signal processing, encoding, and display processing are set in an OFF or standby state. As shown in FIG. 16, only circuits concerning speech recording operate, and speech signals smaller in data amount than video signals are recorded as an emergency workaround. By automatically switching the operation mode to the voice only mode in the low battery level, only speech signals can be continuously recorded.

An operation of adding a beep sound to an input speech signal and recording the resultant signal will be explained with reference to FIG. 20.

In recording only speech signals due to a small residual capacity of the recording medium or a small battery capacity, the control section 119 controls a beep sound generator 131a and adder 131b, and synthesizes a beep sound onto an input speech signal from the microphone 116 at a predetermined time interval. The input speech signal onto which the beep sound is synthesized is compression-encoded by the speech compression/decompression section 118, and recorded in a motion video file via the control section 119. If the user hears the added beep sound while listening to the reproduced speech, he/she can easily understand that the speech is recorded as an emergency workaround because of a small residual capacity of the recording medium or a small battery capacity, and that no long-time speech signals are subsequently recorded.

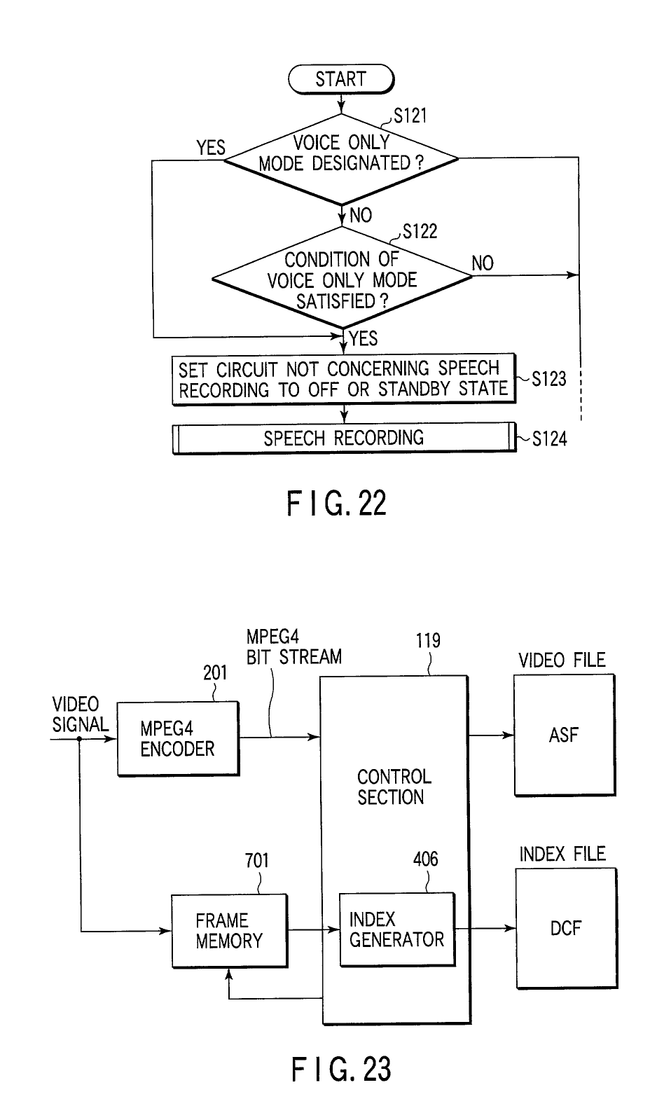

The flow chart of FIG. 22 shows a voice only mode processing sequence by the control section 119.

The control section 119 determines whether the user explicitly designates the voice only mode (step S121). If the user designates the voice only mode (YES in step S121), the control section 119 sets circuits not concerning speech recording in an OFF or periodical state (step S123), and records only speech signals (step S124). Even if NO in step S121, but a decrease in battery or the residual capacity of the recording medium is detected in the motion video shooting and recording mode (YES in step S122), the control section 119 sets circuits not concerning speech recording in an OFF or periodical state (step S123), and records only speech signals (step S124).

<Index Image of Encoded Video File>

Processing of generating the index image of a motion video signal recorded as an encoded motion video file and recording the index image on a recording medium will be described. In the video camera apparatus 11 of this embodiment, a motion video signal obtained by motion video shooting every time a motion video is shot is recorded as an encoded motion video file. An index image is recorded on the recording medium in correspondence with the encoded motion video file, which enables easily presenting to the user the contents of many encoded motion video files recorded on the recording medium. An arrangement for generating and recording the index image is shown in FIG. 23.

As shown in FIG. 23, the control section 119 comprises an index generator 406. The index generator 406 generates an VGA-size JPEG index file (DCF file) as the index image of an encoded motion video file (ASF), and records the index file on the recording medium (built-in flash memory 121 or PCMCIA card type hard disk drive 122) in correspondence with the encoded motion video file (ASF). The index image is generated from one frame of a motion video signal recorded as the encoded motion video file (ASF). For example, the first frame at the start of motion video shooting and recording is stored in a frame memory 701, and an index file (DCF file) is generated by the index generator 406 of the control section 119 on the basis of the contents of the frame memory 701 at the end of motion video shooting and recording.

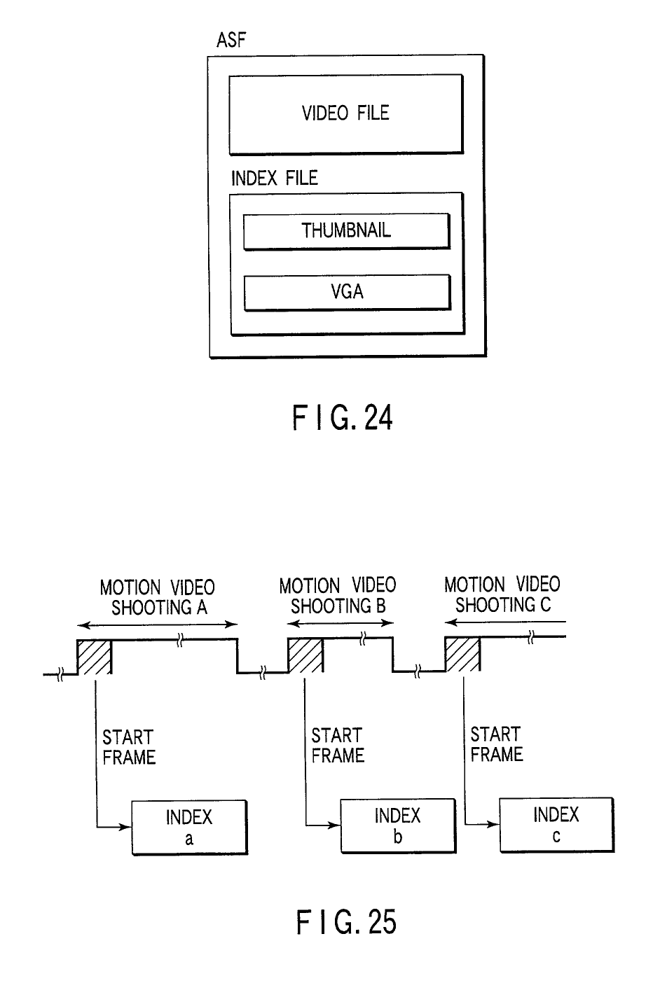

The DCF file has the format of a still video file normally used in a digital still camera, and can contain a thumbnail image (160×120) in addition to a main image. The index file can be recorded as a file other than the encoded motion video file (ASF), or the contents of the index file can also be contained in the encoded motion video file (ASF). This state is shown in FIG. 24. That is, ASF contains an index file including a VGA-size still video and its thumbnail image in addition to a motion video file including a video and speech.

FIG. 25 shows the relationship between the motion video shooting and recording timing and the index image generation timing.

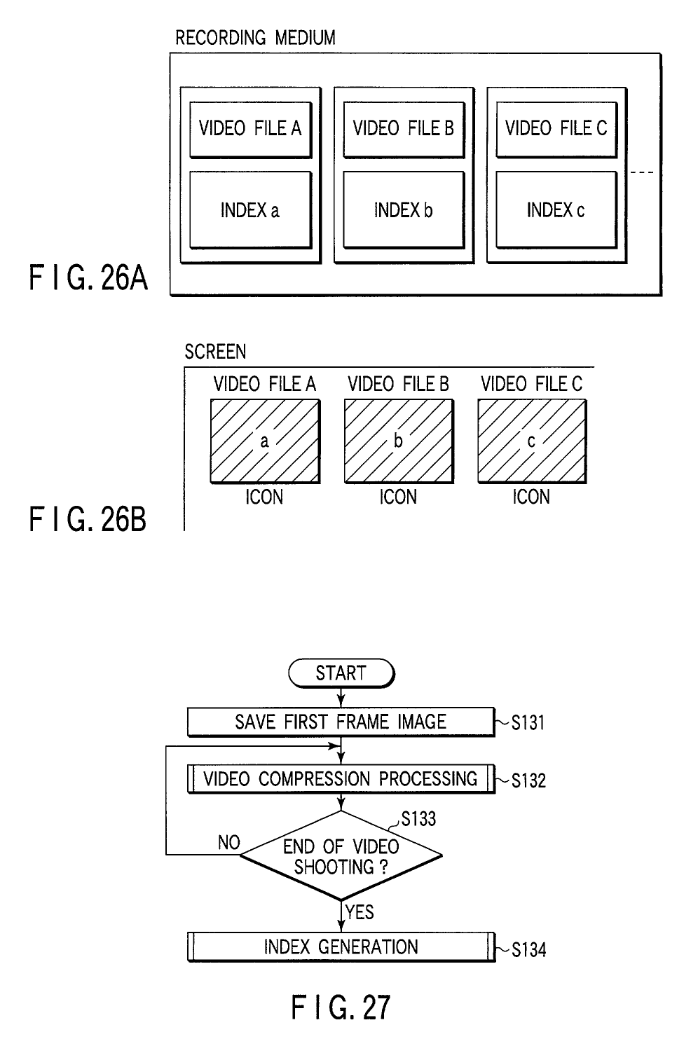

As shown in FIG. 25, when motion videos are shot in an order of “motion video shooting A”, “motion video shooting B”, and “motion video shooting C”, an index image a is generated from the first input frame (start frame) during motion video shooting A, an index image b is generated from the first input frame during motion video shooting B, and an index image c is generated from the first input frame during motion video shooting C. As shown in FIG. 26A, the motion video file A and index a, the motion video file B and index b, and the motion video file C and index c are recorded on the recording medium. The indices a, b, and c are used as icons respectively representing the contents of the motion video files A, B, and C, as shown in FIG. 26B, or used to display a corresponding index image at the beginning in reproducing a motion video file or display an index image in order to confirm the contents of a motion video file selected as a file to be deleted, copied, moved, or the like.

The flow chart of FIG. 27 shows an index image generation processing sequence by the control section 119.

If video shooting/recording starts, the control section 119 saves the video signal of the first frame in the frame memory 701 (step S131). The control section 119 uses the MPEG4 encoder 201 to sequentially execute compression encoding of input motion video signals from the first frame until video shooting/recording ends (steps S132 and S133). If video shooting/recording ends (YES in step S133), the control section 119 compression-encodes the frame images saved in the frame memory 701, and generates still index images (step S134).

<Communication Interface with Personal Computer>

A function of causing the personal computer 13 to recognize the video camera apparatus 11 as a storage device such as a hard disk in connection to the personal computer 13.

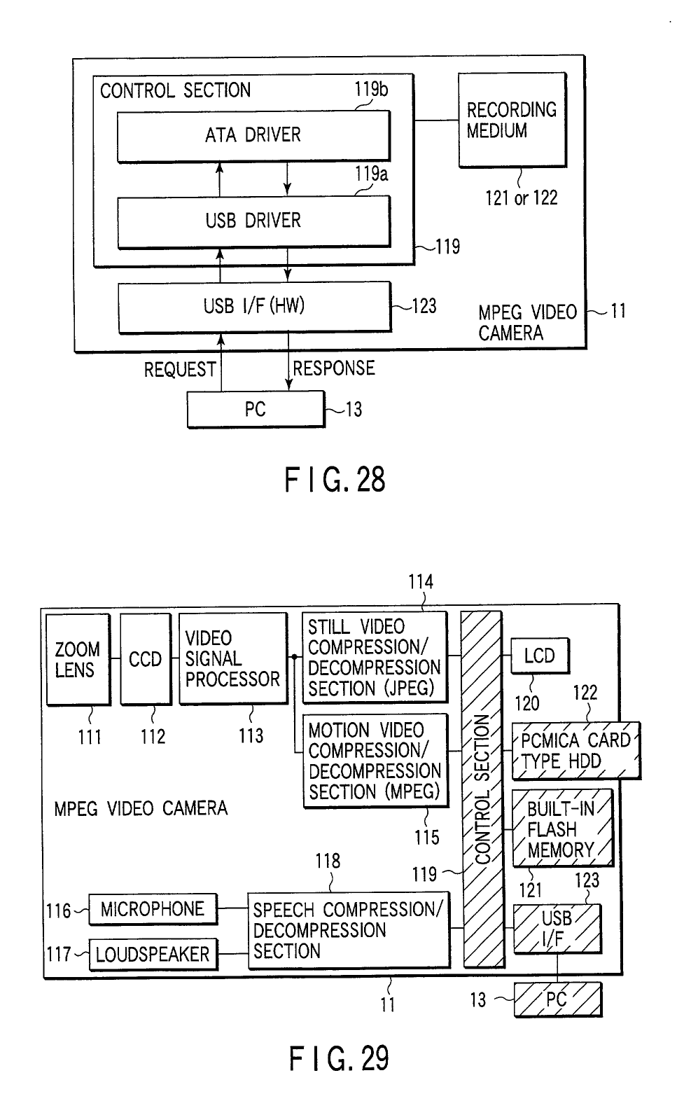

As shown in FIG. 28, the control section 119 comprises a USB driver 119a and ATA (AT Attachment) driver 119b. By executing these programs, the personal computer 13 can be caused to recognize the video camera apparatus 11 as an ATA hard disk device. In other words, when the video camera apparatus 11 is connected to the personal computer 13 via a USB interface, the personal computer 13 issues a request of acquiring the device type by a plug-and-play function, and the request is transferred to the ATA driver 119b via the USB interface 123 and USB driver 119a. Configuration information representing that the video camera apparatus 11 is an ATA hard disk device is sent back to the personal computer 13 via the ATA driver 119b. The ATA driver 119b controls the recording medium (built-in flash memory 121 or PCMCIA card type hard disk drive 122) in accordance with AT commands from the personal computer 13.

If the PCMCIA card type hard disk drive 122 is not mounted on the video camera apparatus 11, the personal computer 13 is informed of property information such as the memory capacity of the built-in flash memory 121, and the file system of the personal computer 13 treats the built-in flash memory 121 as an external hard disk device. The ATA driver 119b accesses the built-in flash memory 121 in accordance with a read/write request by an AT command from the personal computer 13. Then, data such as a motion video file can be easily exchanged between the video camera apparatus 11 and the personal computer 13 by operation from the file system of the personal computer 13.

If the PCMCIA card type hard disk drive 122 is mounted on the video camera apparatus 11, the personal computer 13 is informed of property information such as the memory capacity of the PCMCIA card type hard disk drive 122, and the file system of the personal computer 13 treats the PCMCIA card type hard disk drive 122 as an external hard disk device. The ATA driver 119b accesses the PCMCIA card type hard disk drive 122 in accordance with a read/write request by an AT command from the personal computer 13. Then, data such as a motion video file can be easily exchanged between the video camera apparatus 11 and the personal computer 13 by operation from the file system of the personal computer 13.

FIG. 29 shows the relationship between circuits set in an ON state and circuits set in an OFF or standby state when data such as a motion video file is exchanged between the video camera apparatus 11 and the personal computer 13.

When data such as a motion video file is exchanged between the video camera apparatus 11 and the personal computer 13, only circuits hatched in FIG. 29 operate. This can minimize the power consumption of the video camera apparatus 11 when connecting it to the personal computer 13, and can prolong the usable time of the video camera apparatus 11 serving as the storage device of the personal computer 13.

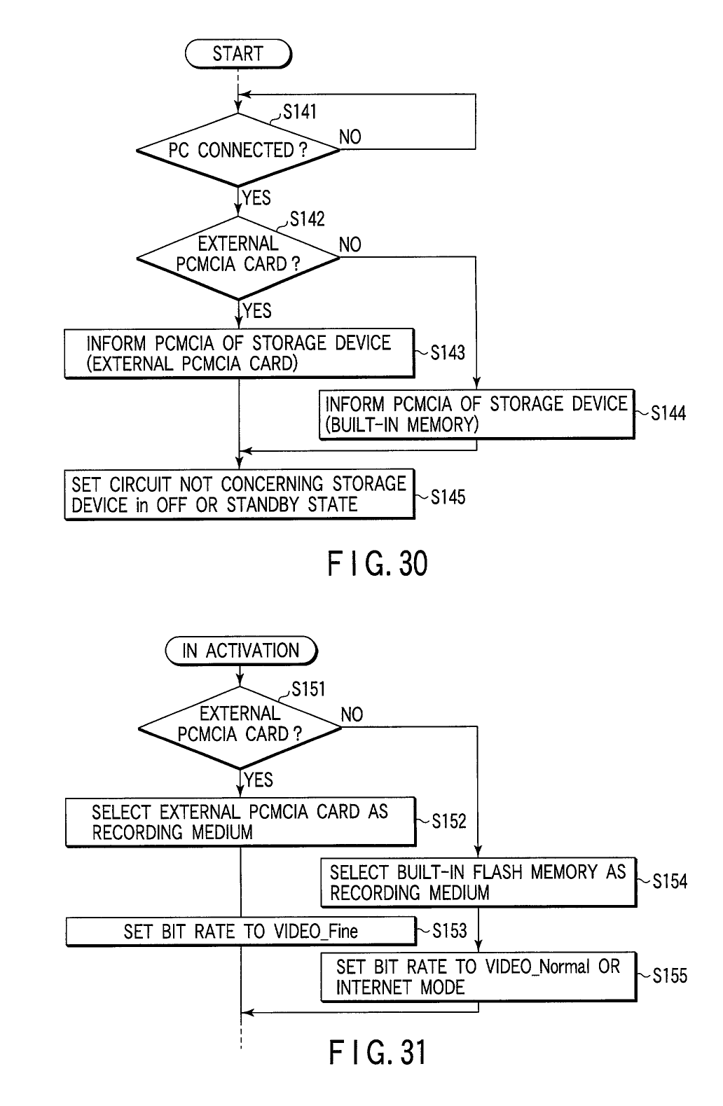

The flow chart of FIG. 30 shows a processing sequence by the control section 119 in connection to the personal computer 13.

If the control section 119 detects connection to the personal computer 13 via the USB interface 123 (YES in step S141), the control section 119 checks whether the PCMCIA card type hard disk drive 122 is mounted (step S142). If YES in step S142, the control section 119 sends back to the personal computer 13 a message that the video camera apparatus 11 is a storage device (PCMCIA card type hard disk drive 122), and informs the personal computer 13 of property information of the PCMCIA card type hard disk drive 122 or the like (step S143). If NO in step S142, the control section 119 sends back to the personal computer 13 a message that the video camera apparatus 11 is a storage device (built-in flash memory 121), and informs the personal computer 13 of property information of the built-in flash memory 121 or the like (step S144). After that, the control section 119 sets circuits not concerning data transfer between the personal computer 13 and the storage device in an OFF or standby state (step S145), and accesses the built-in flash memory 121 or PCMCIA card type hard disk drive 122 in this state in accordance with a file access request from the personal computer 13.

<Activation Processing>

Processing performed by the control section 119 in turning on the video camera apparatus 11 will be described with reference to the flow chart of FIG. 31.

The control section 119 initializes each section in the video camera apparatus 11, and checks during initialization processing whether the PCMCIA card type hard disk drive 122 is mounted or not (step S151). If YES in step S151, the control section 119 selects the PCMCIA card type hard disk drive 122 as a recording medium for recording a motion video or still video file obtained by video shooting (step S152). The default motion video shooting and recording mode is set to, e.g., FINE as a predetermined resolution in the VIDEO mode (step S153). If NO in step S151, the control section 119 selects the built-in flash memory 121 as a recording medium for recording a motion video or still video file obtained by video shooting (step S154). The default motion video shooting and recording mode is set to a mode at a lower bit rate than in the use of the PCMCIA card type hard disk drive 122 as a recording medium, e.g., NORMAL as a predetermined resolution in the VIDEO mode, or to the INTERNET mode (step S155). The target bit rate can be optimized by automatically setting the default value of the target bit rate in video shooting/recording in accordance with the type of recording medium used.

As described above, this embodiment adopts a method of compression-encoding a motion video signal obtained by video shooting in accordance with the MPEG4 standard, and recording the encoded signal as a motion video file. This embodiment can implement a video camera highly compatible with a computer by setting the Internet mode or the like.

As has been described above, according to the present invention, a video file compatible between the Internet and a computer can be obtained by video shooting.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A video camera apparatus comprising:
a solid state image sensor;
a video encoding section configured to perform compression encoding including intra-frame encoding and inter-frame encoding for a video signal input from said solid state image sensor;
a recording section configured to record the video signal compression-encoded by said video encoding section as a video file on a recording medium; and
a control section configured to execute a first motion video shooting and recording mode for obtaining a video file including the compression-encoded video signal to be transmitted in real time to a partner destination via a network, and to control said video encoding section to match a bit rate of an encoded video signal obtained by said video encoding section with a communication speed of the network used to transmit the video file when the first motion video shooting and recording mode is selected.

2. An apparatus according to claim 1, which further comprises:
a speech signal input section configured to input a speech signal;
a speech signal encoding section configured to perform compression encoding to the speech signal input from said speech signal input section; and
a generation section configured to multiplex the speech signal compression-encoded by said speech signal encoding section and the compression-encoded video signal and generate the video file, and
said control section controls said speech signal encoding section to match a bit rate of an encoded speech signal obtained by said speech signal encoding section with the communication speed of the network used to transmit the video file when the first motion video shooting and recording mode is selected.

3. An apparatus according to claim 1, wherein said control section further is configured to execute a second motion video shooting and recording mode for recording an encoded signal having a higher bit rate than in the first motion video shooting and recording mode as a video file, and when the second motion video shooting and recording mode is selected, said control section is configured to control said video encoding section to set the bit rate of the encoded video signal obtained by said video encoding section to be higher than in the first motion video shooting and recording mode.

4. An apparatus according to claim 1, further comprising an option selection section configured to select an encoding option to be executed by said video encoding section,
said option selection section comprising:
a detection section configured to detect an encoding delay by said video encoding section, and
an omission section configured to switch encoding by said video encoding section to intra-frame encoding, and to cause said video encoding section to omit inter-frame encoding when the encoding delay is detected.

5. An apparatus according to claim 1, further comprising an option selection section configured to select an encoding option to be executed by said video encoding section,
said option selection section comprising:
a determination section configured to determine whether a motion vector size obtained by encoding of said video encoding section is larger than a predetermined value; and
an omission section configured to switch encoding by said video encoding section to intra-frame encoding, and to cause said video encoding section to omit inter-frame encoding when the motion vector size is larger than the predetermined value.

6. An apparatus according to claim 1, further comprising:
a hand blurring detection section configured to detect hand blurring of said video camera apparatus; and
an option selection section configured to select an encoding option to be executed by said video encoding section,
said option selection section comprising an omission section configured to switch encoding by said video encoding section to intra-frame encoding, and to cause said video encoding section to omit inter-frame encoding when an amount of hand blurring detected by said hand blurring detection section is larger than a predetermined value.

7. An apparatus according to claim 1, further comprising:
an interval shot mode section configured to execute an interval shot mode in which one frame or a plurality of successive frames are repetitively shot after a predetermined interval time, and
an omission section configured to switch encoding of said video encoding section which receives one frame or a plurality of successive frames after the predetermined interval time, to intra-frame encoding in the interval shot mode, and to cause said video encoding section to omit inter-frame encoding.

8. An apparatus according to claim 1, further comprising:
an interval shot mode section configured to execute an interval shot mode in which one frame or a plurality of successive frames are repetitively shot after a predetermined interval time, and
a displacement section configured to displace, by another virtual value, a time stamp value of each frame added to the compression-encoded video signal recorded as the video file in the interval shot mode.

9. An apparatus according to claim 1, further comprising:
a speech signal input section configured to input a speech signal;
a speech signal encoding section configured to perform compression encoding for the speech signal input from said speech signal input section;
a multiplexing section configured to multiplex the compression-encoded speech signal onto the compression-encoded video signal to record the speech signal compression-encoded by said speech signal encoding section together with the compression-encoded video signal as a video file; and
a speech recording section configured to execute a speech recording mode in which only a speech signal is recorded, and to set said solid state image sensor and said video encoding section in an OFF or standby state in the speech recording mode.

10. An apparatus according to claim 9, further comprising a control section configured to control switching to the speech recording mode on the basis of a residual capacity of the recording medium or a battery residual capacity of said video camera apparatus.

11. An apparatus according to claim 1, further comprising an index image generation section configured to generate an index image of the video signal recorded as the video file on the basis of a predetermined 1-frame image signal obtained from said solid state image sensor, and record the index image on the recording medium.

12. An apparatus according to claim 11, wherein said index image generation section generates an index image including the predetermined one-frame image and a reduced image of the predetermined one-frame image.

13. An apparatus according to claim 11, wherein the predetermined one-frame image includes a first one-frame image at start of video shooting.

14. An apparatus according to claim 1, further comprising:
a communication interface configured to connect said video camera apparatus to an information processing device;
a recognition section configured to cause said information processing device to recognize said video camera apparatus as a storage device when said video camera apparatus is connected to said information processing device via said communication interface; and
a control section configured to control said recording medium of said video camera apparatus in accordance with an access request from the information processing device to the storage device.

15. An apparatus according to claim 14, wherein said recording medium includes an internal storage device built into said video camera apparatus, or an external storage device detachably mounted in said video camera apparatus.

16. An apparatus according to claim 15, further comprising:
a detection section configured to detect whether said external storage device is mounted; and
a switching section configured to switch a recording medium used as a recording destination of the video file and a recording medium used as the storage device by the information processing device, from the internal storage device to the external storage device when the external storage device is mounted.

17. A video camera apparatus comprising:
a solid state image sensor;
a video encoding section configured to perform compression encoding including intra-frame encoding and inter-frame encoding for a video signal input from said solid state image sensor;
a recording section configured to record the video signal compression-encoded by said video encoding section as a video file on a recording medium; and
a control section configured to control a compression ratio of the video signal obtained by said video encoding section in accordance with an application purpose of the video file, to execute selectively a first motion video shooting and recording mode for obtaining a video file including the compression-encoded video signal to be transmitted in real time to a partner destination via a network, and a second motion video shooting and recording mode for recording an encoded video signal having a higher bit rate than in the first motion video shooting and recording mode as a video file, and to set a target bit rate of the encoded signal with respect to said video encoding section in accordance with a selected one of the first and second motion video shooting and recording modes.

18. A video camera apparatus comprising:
a solid state image sensor;
a video encoding section configured to perform compression encoding including intra-frame encoding and inter-frame encoding for a video signal input from said solid state image sensor;
a recording section configured to record the video signal compression-encoded by said video encoding section as a video file on a recording medium; and
a displacement section configured to execute an interval shot mode in which one frame or a plurality of successive frames are repetitively shot after a predetermined interval time, and to displace, by another virtual value, a time stamp value of each frame added to the compression-encoded video signal recorded as the video file in the interval shot mode.

19. A video camera apparatus which can selectively use an internal storage device and a detachably mountable external storage device as a recording medium, comprising:
a solid state image sensor;
a video encoding section configured to perform compression encoding including intra-frame encoding and inter-frame encoding for a video signal input from said solid state image sensor;
a recording section configured to record the video signal compression-encoded by said video encoding section as a video file in an internal or external storage device;
an external storage device detection section configured to detect whether the external storage device is mounted;
a variable setting section configured to variably set a target bit rate value of an encoded signal designated to said video encoding section on the basis of a detection result by said external storage device detection section to obtain a video file having higher quality when the external storage device is mounted than quality when the external storage device is not mounted.

20. A video camera apparatus comprising:
a solid state image sensor;
a video encoding section configured to perform compression encoding including intra-frame encoding and inter-frame encoding for a video signal input from said solid state image sensor;
a recording section configured to record the video signal compression-encoded by said video encoding section as a video file on a recording medium; and
an option selection section configured to select an encoding option to be executed by said video encoding section,
said option selection section including:
a detection section configured to detect an encoding delay by said video encoding section; and
a control section configured to control the encoding option by said video encoding section to realize encoding at a designated target frame rate when the encoding delay is detected.

21. A video camera apparatus comprising:
a solid state image sensor;
a video encoding section configured to perform compression encoding including intra-frame encoding and inter-frame encoding for a video signal input from said solid state image sensor;
a recording section configured to record the video signal compression-encoded by said video encoding section as a video file on a recording medium; and
an option selection section configured to select an encoding option to be executed by said video encoding section,
said option selection section including:
a determination section configured to determine whether a motion vector size obtained by encoding of said video encoding section is larger than a predetermined value; and
an omission section configured to switch encoding by said video encoding section to intra-frame encoding, and to cause said video encoding section to omit inter-frame encoding when the motion vector size is larger than the predetermined value.

22. A video camera apparatus comprising:
a solid state image sensor;
a video encoding section configured to perform compression encoding including intra-frame encoding and inter-frame encoding for a video signal input from said solid state image sensor;
a recording section configured to record the video signal compression-encoded by said video encoding section as a video file on a recording medium;
a hand blurring detection section configured to detect hand blurring; and
an option selection section configured to select an encoding option to be executed by said video encoding section,
said option selection section including:
an omission section configured to switch encoding by said video encoding section to intra-frame encoding, and to cause said video encoding section to omit inter-frame encoding when an amount of hand blurring detected by said hand blurring detection section is larger than a predetermined value.

23. A video camera apparatus comprising:
a solid state image sensor;
a video encoding section configured to perform compression encoding including intra-frame encoding and inter-frame encoding for a video signal input from said solid state image sensor;
a recording section configured to record the video signal compression-encoded by said video encoding section as a video file on a recording medium;
a speech signal input section configured to input a speech signal;
a speech signal encoding section configured to perform compression encoding for the speech signal input from said speech signal input section;
a multiplexing section configured to multiplex the compression-encoded speech signal onto the compression-encoded video signal to record the speech signal compression-encoded by said speech signal encoding section together with the compression-encoded video signal as a video file; and
a speech recording mode section configured to execute a speech recording mode in which only a speech signal is recorded, and to set said solid state image sensor and said video encoding section in an OFF or standby state in the speech recording mode.

24. A video camera apparatus comprising:
a solid state image sensor;
a video encoding section configured to perform compression encoding including intra-frame encoding and inter-frame encoding for a video signal input from said solid state image sensor;
a recording section configured to record the video signal compression-encoded by said video encoding section as a video file on a recording medium;
a communication interface configured to connect said video camera apparatus to an information processing device;
a recognition section configured to cause the information processing device to recognize said video camera apparatus as a storage device when said video camera apparatus is connected to the information processing device via said communication interface; and
a control section configured to control the recording medium of said video camera apparatus in accordance with an access request from the information processing device to the storage device.
